(19) United States
(12) Patent Application Publication
(10) Pub. No.: US 2010/0283924 A1
(43) Pub. Date: Nov. 11, 2010

(54) Stereoscopic Display Device

(76) Inventors: Ming-Shu Lee, Taipei County (TW); Chun-Fu Liu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/568,686

(22) Filed: Sep. 29, 2009

(30) Foreign Application Priority Data
May 6, 2009 (TW) 098207718

(51) Int. Cl. G02F 1/13357

(52) U.S. Cl. 349/15

(57) ABSTRACT

A stereoscopic display device includes a stereoscopic display unit, a backlight module and an outer frame. The stereoscopic display unit includes an LCD panel and a parallax barrier opposite to each other. The backlight module is disposed on a side of the stereoscopic display unit and includes a light source and a rubber frame, wherein the rubber frame is disposed on an outer side of the light source. The outer frame encompasses the stereoscopic display unit and the backlight module. At least one of the rubber frame and the outer frame includes a light shielding component disposed on a side facing the light source to prevent light leakage form an edge of the stereoscopic display unit.

### BACKGROUND OF THE INVENTION

1. Field of the Invention

The present invention relates to a stereoscopic display device, and more particularly to a stereoscopic display device that can prevent light leakage from the edge of the display region.

2. Description of the Prior Art

As the photovoltaic technology and semiconductor technology become mature in current years, various types of flat display panels have been developed vigorously. The liquid crystal display (LCD) panel that has the advantages of low-power-consumption, low-radiation, light-weight and small-size has become the most popular display product. However, in a current LCD panel, its flat two-dimensional (2D) display mode has been unable to meet the needs of the users. The research units are committed to the development of 3D display technology, hoping to make the observer perceive a 3D stereoscopic vision under a 2D display environment.

The present 3D stereoscopic display technology is to use a parallax barrier to provide different images to the left eye and the right eye individually, so that the observer can sense a stereoscopic image. In general, the parallax barrier can be a simple grating structure made of plastics or metals like chromium, or be an LCD panel. Using an LCD panel as a parallax barrier can not only produce a 3D stereoscopic image. It also can be switched between 2D/3D modes freely by controlling the power.

In addition to a conventional backlight module and a display panel, the stereoscopic display device should further contain a parallax barrier, making the overall thickness and volume increase. Many problems that are not easy to arise in a conventional 2D LCD panel will occur. Please refer to FIG. 1, illustrating a structure schematic diagram of a conventional 2D LCD device. A conventional 2D LCD device includes an LCD panel 100, a backlight module 102 and an outer frame 110. The LCD panel 100 is disposed on the backlight module 102. The backlight module 102 can provide needed display light for the LCD panel 100. The backlight module 102 includes a light source 104, a plurality of optical sheets 106 and a rubber frame 108. Light emitted from the light source 104 can become a flat light source by the scattering effect of the optical sheets 106 and reach to the LCD panel 100 so that a visible image can be obtained. The rubber frame 108 is disposed around the light source 104 so as to fix the light source 104, the optical sheets 106 and the LCD panel 100. The outer frame 110 is disposed on an outer side of the LCD panel 100 and the backlight module 102 so as to support the LCD panel 100 and the backlight module 102.

Please continue to refer to FIG. 1. When the light source 104 is turned on, most generated light emits upwardly from the light source 104, and penetrates through the optical sheets 106. But there is still a portion of light that is irradiated on the inner side of the rubber frame 108 and reflected from the surface of the rubber frame 108, making the light pass from the edge of the LCD panel 100 into the outside environment, resulting in the light leakage phenomenon and thus impacting the display quality. In order to solve the light leakage problem, the outer frame 110 usually includes an extension part 112 disposed over the LCD panel 100, as shown in FIG. 1. By the blocking function of the extension part 112, the possibility of light leakage into the outside environment (for example, the pathway of Light A in FIG. 1) can decrease so as to prevent the light leakage phenomenon.

Please refer to FIG. 2, illustrating a structure schematic diagram of a conventional stereoscopic display device. As shown in FIG. 2, in addition to the LCD panel 100, the backlight module 102 and the outer frame 110, a conventional stereoscopic display device further includes a parallax barrier 114 disposed on the other side of the LCD panel 100 opposite to the backlight module 102. Compared to the conventional 2D LCD device, the parallax barrier 114 increases the overall thickness of the stereoscopic display device. Light which is originally blocked by the extension part 112 becomes unable to be blocked by the extension part 112 and leaks out from the edge of the LCD panel 100. As shown in FIG. 2, after reflecting from the inner surface of the rubber frame 108, Light B passes by the original position of the extension part 112 (represented in a dashed line area P in FIG. 2) which can originally block light in conventional arts. Because the thickness of the stereoscopic display device has been changed and the position of the extension part 112 is changed as well, Light B can not be blocked anymore, leading to the light leakage phenomenon. Or, as the thickness of the stereoscopic display device increases, the possibility of light reflecting from the inner surface of the outer frame 110 and leaking from the edge of the LCD panel 100 also increases, as shown in Light C in FIG. 2. Because the outer frame 110 usually includes high reflective materials such as metals, the possibility of light refection increases as well, resulting in serious light leakage problem.

### SUMMARY OF THE INVENTION

The present invention provides a well-designed stereoscopic display device so as to overcome the light leakage problem in conventional stereoscopic display devices.

According to the claimed invention, a stereoscopic display device is provided. The stereoscopic display device includes a stereoscopic display unit, a backlight module and an outer frame. The stereoscopic display unit includes a liquid crystal display panel and a parallax barrier, wherein the LCD panel is disposed opposite to the parallax barrier. The backlight module is disposed on a side of the stereoscopic display unit. The backlight module includes a light source and a rubber frame, wherein the rubber frame is disposed on an outer side of the light source. The outer frame is disposed on an outer side of the stereoscopic display unit and the backlight module. The outer frame encompasses the stereoscopic display unit and the backlight module, wherein at least one of the rubber frame and the outer frame includes a light shielding component disposed on a side facing the light source to prevent light leakage from an edge of the stereoscopic display unit.

In the present invention, the light shielding component is disposed on the side of the rubber frame and the outer frame facing the light source, so light emitted from the light source is absorbed or scattered by the light shielding component and the light leakage problem in conventional stereoscopic display device can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a structure schematic diagram of a conventional 2D LCD device.

FIG. 2 illustrates a structure schematic diagram of a conventional stereoscopic display device.

FIG. 3 illustrates a schematic diagram of the first embodiment of the stereoscopic display device in the present invention.

FIG. 4 and FIG. 5 illustrate schematic diagrams of the light shielding micro-structures of the light shielding component in the present invention.

FIG. 6 illustrates a schematic diagram of the second embodiment of the stereoscopic display device in the present invention.

FIG. 7 illustrates a schematic diagram of the third embodiment of the stereoscopic display device in the present invention.

FIG. 8 illustrates a schematic diagram of the fourth embodiment of the stereoscopic display device in the present invention.

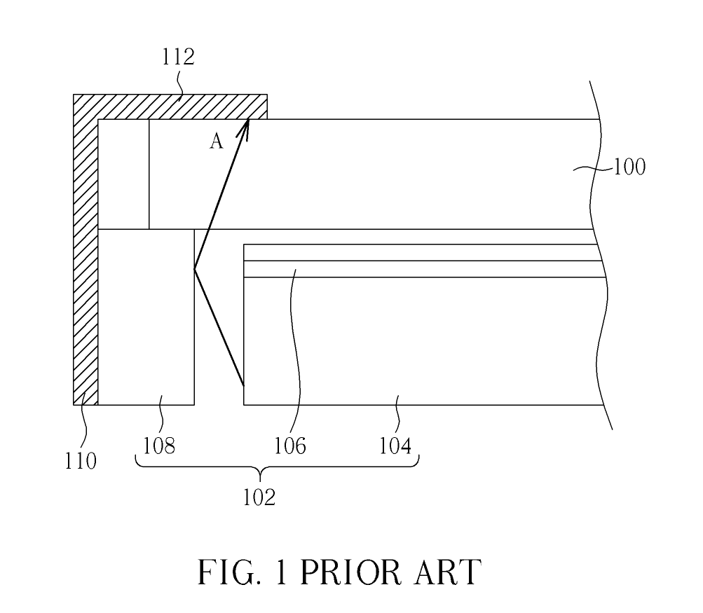

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . .”

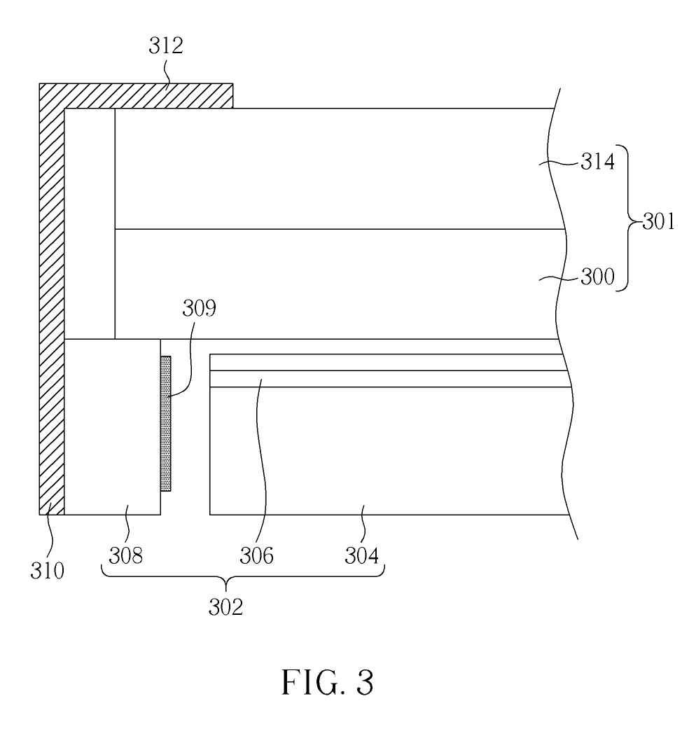

Please refer to FIG. 3, illustrating a schematic diagram of the first embodiment of the stereoscopic display device in the present invention. As shown in FIG. 3, the stereoscopic display device in the present invention includes a stereoscopic display unit 301, a backlight module 302 and an outer frame 310. The stereoscopic display unit 301 includes a liquid crystal display panel 300 and a parallax barrier 314, both of which are opposite to each other and are disposed above the backlight module 302. The sequence of the LCD panel 300 and the parallax barrier 314 can be altered, for example, the LCD panel 300 can be disposed above the parallax barrier 314 or the parallax barrier 314 can be disposed above the LCD panel 300. The LCD panel 300 can provide images for observers to view. The parallax barrier 314 can separate displayed images into the left eye information and the right eye information so that the observer can sense a stereoscopic image. The parallax barrier 314 can be a simple grating structure made of plastics or metals, or can be another LCD panel.

The backlight module 302 is disposed on a side of the stereoscopic display unit 301, providing needed display light for the stereoscopic display unit 301. The backlight module 302 includes a light source 304, a rubber frame 308 and a plurality of optical sheets 306. The light source 304 can be a cold cathode fluorescent lamp (CCFL), a light emitting diode (LED) or other devices that can emit light. The optical sheets 306 are disposed between the light source 304 and the stereoscopic display unit 301, so light emitted from the light source 304 can pass through the optical sheets 306 and become a flat light source by the scattering effect of the optical sheets 306. The rubber frame 308 is disposed on an outer side of the light source 304. The rubber frame 308 can support the stereoscopic display unit 301, the optical sheets 306 and the light source 304. The rubber frame 308 usually includes plastic materials. The outer frame 310 is disposed on an outer side of the stereoscopic display unit 301 and the backlight module 302. The outer frame 310 encompasses the stereoscopic display unit 301 and the backlight module 302 and usually includes metal materials.

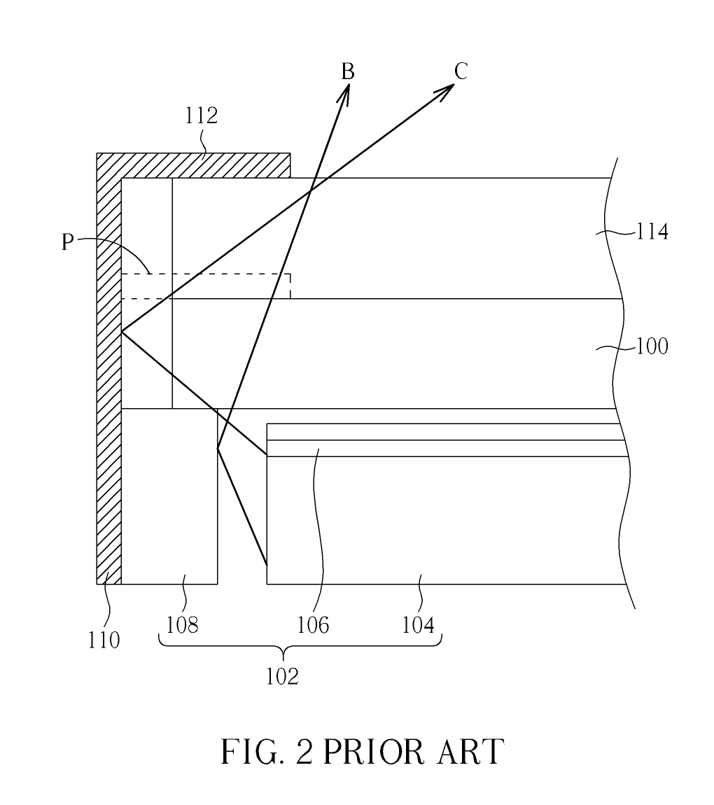

As shown in FIG. 3, in order to prevent the light leakage phenomenon in conventional arts as shown in FIG. 2, the stereoscopic display device in the present invention includes a light shielding component 309 disposed on a side of the rubber frame 308 facing the light source 304. The light shielding component 309 has unique light shielding structures or materials such that light emitted from the light source 304 can be absorbed or scattered herein and the light leakage phenomenon can be avoided. The position or the covering area of the light shielding component 309 can be adjusted according to different circumstances, for example, adjust the height of the light shielding component 309 upwardly or downwardly, or increase its covering area to fully cover the side of the rubber frame 308 facing the light source 304 to obtain the best light shielding effect.

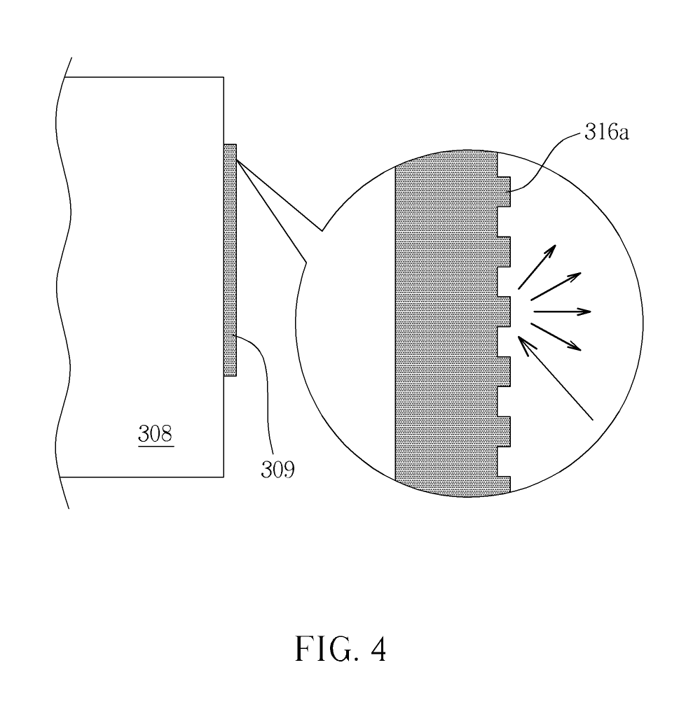

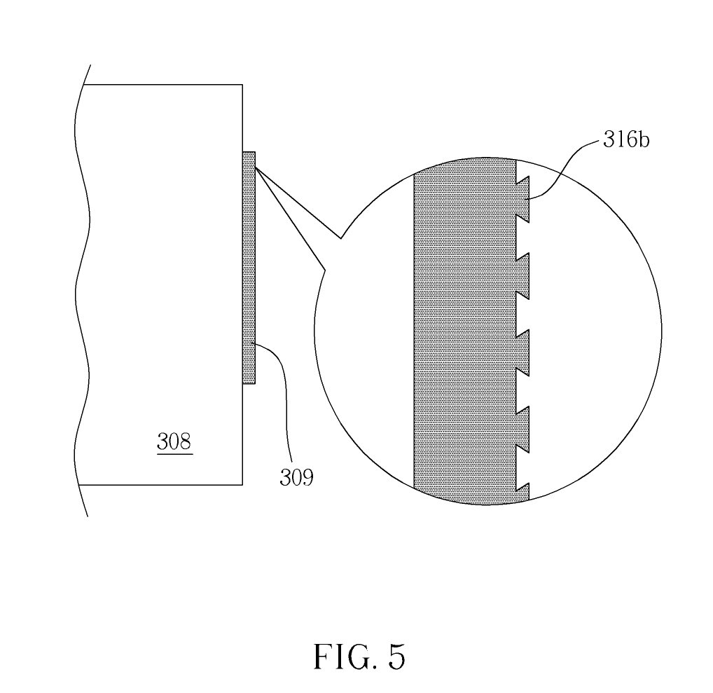

In order to have better shielding effect, the light shielding component 309 in the present invention has unique light shielding micro-structures on its surface. Please refer to FIG. 4 and FIG. 5, illustrating schematic diagrams of the light shielding micro-structures of the light shielding component in the present invention. As shown in FIG. 4, the light shielding component 309 on the rubber frame 308 has a plurality of light shielding micro-structures 316 on its surface. The light shielding micro-structures 316 can unevenly reflect light, thereby causing scattering effect such that the light leakage phenomenon in conventional arts that light pass through the edge of the stereoscopic display unit 301 after a direct reflection can be avoided. The shape of the light shielding micro-structures 316 can be a protruding rectangle 316a, as shown in FIG. 4, or can be a protruding trapezoid 316b, as shown in FIG. 5. The shape of the light shielding micro-structures 316 can also be other geometric shapes such as a semi-sphere or a prism but should not be limited thereto. The principle is that the shape should be able to meet the function to scatter light.

On the other hand, the light shielding component 309 can be made of unique light shielding materials, for example, a light absorption material, to absorb light emitted from the light source 304 and to prevent light leakage from the edge of the stereoscopic display unit 301 via a reflection route. The light absorption material includes a variety of low-reflective metal or metal oxide, a variety of light shielding tapes such as polyethylene terephthalate, or a variety of paints such as polyester resin. The color of the above-mentioned light absorption material is preferably dark and black color may be the most suitable because it can most reach the effect of absorbing light. The light shielding component 309 should not be limited to the embodiments mentioned above, but can include any combinations of the “light shielding micro-structures” and the “light absorption materials.” For example, the light shielding component 309 can be “a metal oxide with rectangle micro-structure” or “a light shielding tape with mound micro-structure”, which can be coupled arbitrarily to obtain good light shielding effect.

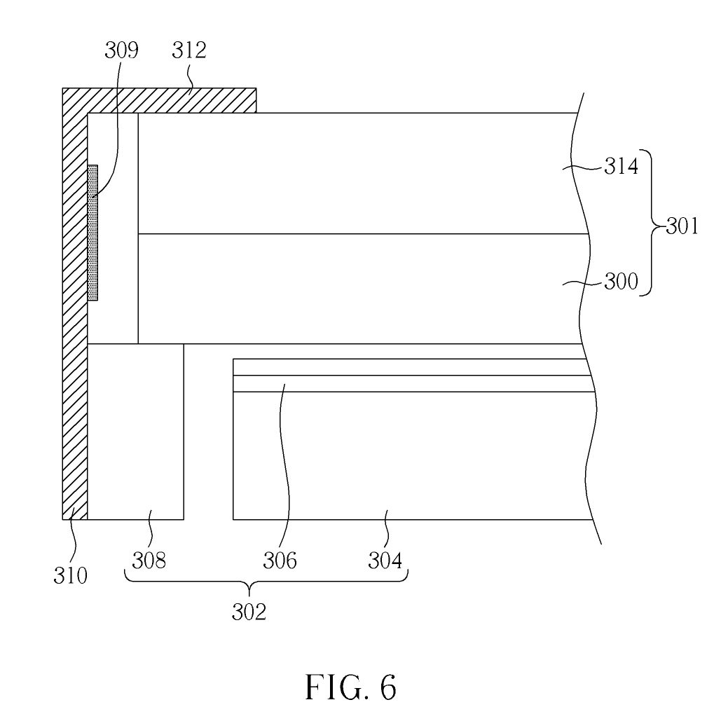

In the second embodiment of the present invention, in addition to the rubber frame 308, the light shielding component 309 can also be disposed on a side of the outer frame 310 facing the light source 304. Please refer to FIG. 6, illustrating a schematic diagram of the second embodiment of the stereoscopic display device in the present invention. As shown in FIG. 6, because the outer frame 310 is usually made of high reflective materials such as metals, in order to prevent light leakage when reflected from the inner side of the outer frame 310, the light shielding component 309 can also be disposed on the inner surface of the outer frame 310 facing the light source 304. The position or the covering area of the light shielding component 309 can be adjusted according to different circumstances, for example, adjust the height of the light shielding component 309 upwardly or downwardly, or increase its covering area to fully cover the side of the outer frame 310 facing the light source 304.

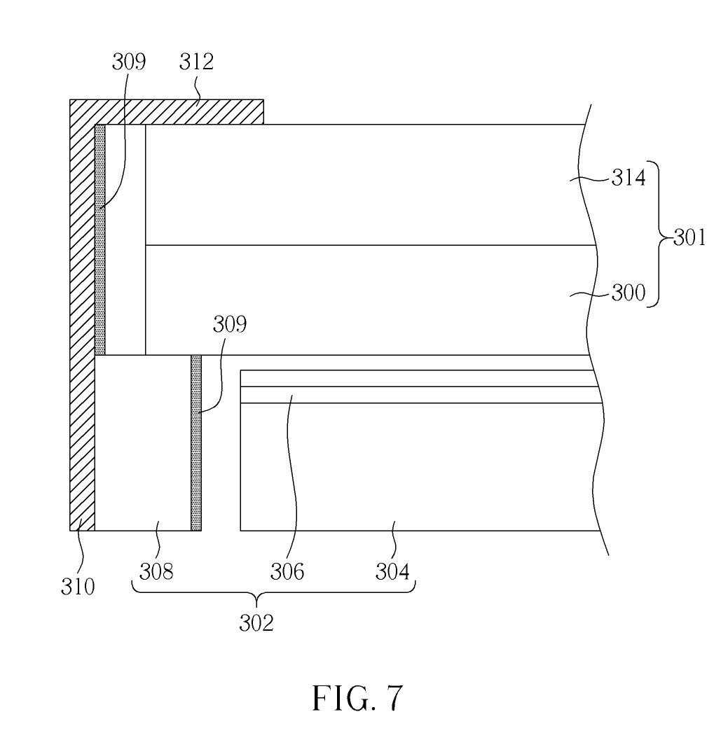

In the third embodiment of the present invention, the light shielding component 309 can be disposed both on the rubber frame 308 and the outer frame 310. Please refer to FIG. 7, illustrating a schematic diagram of the third embodiment of the stereoscopic display device in the present invention. In order to increase the light shielding effect, the light shielding component 309 can be disposed both on the side of the rubber frame 308 and the outer frame 310 facing the light source 304. Similarly, the position or the covering area of the light shielding component 309 can adjusted. An example of the light shielding component 309 fully covering the side of the rubber frame 308 and the outer frame 310 facing the light source 304 is provided in FIG. 7.

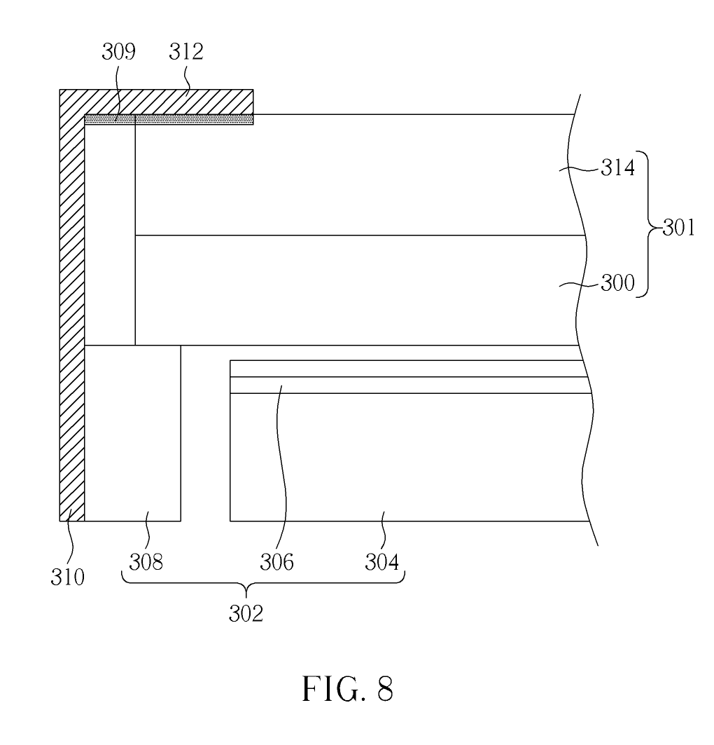

In the fourth embodiment of the present invention, the outer frame 310 further includes an extension part 312 disposed over the stereoscopic display unit 301. The extension part 312 can clamp the stereoscopic display unit 301 together with the rubber frame 308 to prevent light leakage from the edge. Please refer to FIG. 8, illustrating a schematic diagram of the fourth embodiment of the stereoscopic display device in the present invention. As shown in FIG. 8, in addition to the side of the rubber frame 308 or the outer frame 310, the light shielding component 309 could also be disposed on the extension part 312 of the outer frame 310. The light shielding component 309 on the extension part 312 can be coupled with the light shielding component 309 on the rubber frame 308 or the outer frame 310 arbitrarily. For example, the light shielding component 309 can be disposed on the extension part 312 and the rubber frame 308, or on the extension part 312 and the outer frame 310, or all on the three locations.

Referring to the formation method of the light shielding component 309, if the light shielding component 309 is located on the outer frame 310, various types of stamping or coating technologies could be applied. If the light shielding component 309 is located on the rubber frame 308, besides the above-mentioned technologies, the injection molding technology could be used, making the light shielding component 309 and the rubber frame 308 monolithic to simply the following fabrication processes.

In light of above, the stereoscopic display device includes a novel light shielding component disposed on the side of the rubber frame or the outer frame. Light emitted from the light source is absorbed or scattered herein to prevent light leakage from the edge of the stereoscopic display unit so as to overcome the light leakage phenomenon in conventional stereoscopic display device.

Those skilled in the art will readily observe that numerous modifications and alterations of the device and method may be made while retaining the teachings of the invention.

What is claimed is:

1. A stereoscopic display device, comprising:
a stereoscopic display unit comprising a liquid crystal display (LCD) panel and a parallax barrier, wherein the LCD panel is disposed opposite to the parallax barrier;
a backlight module disposed on a side of the stereoscopic display unit, the backlight module comprising a light source and a rubber frame, wherein the rubber frame is disposed on an outer side of the light source; and
an outer frame disposed on an outer side of the stereoscopic display unit and the backlight module, the outer frame encompassing the stereoscopic display unit and the backlight module, wherein at least one of the rubber frame and the outer frame comprises a light shielding component disposed on a side facing the light source to prevent light leakage from an edge of the stereoscopic display unit.

2. The stereoscopic display device as in claim 1, wherein the outer frame further comprises an extension part disposed over the stereoscopic display unit, wherein the extension part clamps the stereoscopic display unit with the rubber frame, and the light shielding component is further disposed on a side wall of the extension part facing the stereoscopic display unit.

3. The stereoscopic display device as in claim 1, wherein the outer frame comprises metal material.

4. The stereoscopic display device as in claim 1, wherein the rubber frame comprises plastic material.

5. The stereoscopic display device as in claim 1, wherein the light shielding component and the rubber frame are monolithic.

6. The stereoscopic display device as in claim 1, wherein the light shielding component comprises a plurality of light shielding micro-structures.

7. The stereoscopic display device as in claim 1, wherein the light shielding component comprises light absorption material.

8. The stereoscopic display device as in claim 7, wherein the light absorption material comprises metal or metal oxide.

9. The stereoscopic display device as in claim 7, wherein the light absorption material comprises a light shielding tape.

10. The stereoscopic display device as in claim 9, wherein the light shielding tape comprises polyethylene terephthalate.

11. The stereoscopic display device as in claim 7, wherein the light absorption material comprises dark paints.

12. The stereoscopic display device as in claim 11, wherein the dark paints comprise polyester resin.
